(19) United States
(12) Patent Application Publication
(10) Pub. No.: US 2008/0120133 A1
(43) Pub. Date: May 22, 2008

(54) Method for predicting the payment of medical debt

(76) Inventors: Arvind Krishnaswami, Roswell, GA (US); Christophe Conseil, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 11/603,528

(22) Filed: Nov. 21, 2006

(51) Int. Cl. G06Q 50/00

(52) U.S. Cl. 705/2

(57) ABSTRACT

The present invention provides methods, systems, and computer program products that are useful for establishing contractual terms and agreements between health care providers and health care payors. For example, one embodiment of the present invention provides a method for predicting a person's payment of a medical debt. Another embodiment of the present invention provides a method for predicting a propensity of a group of one or more health care participants to pay an actual or potential medical debt.

### BACKGROUND OF THE INVENTION

In 2004, health care spending in the United States reached $1.9 trillion, and was projected to reach $2.9 trillion in 2009. In 2004, the United States spent 16 percent of its gross domestic product (GDP) on health care. It is projected that the percentage will reach 20 percent in the next decade. During the last few decades, many employers added health care benefits, and associated insurance to employees as a way of attracting quality workforce in lieu of cash compensation.

Premiums for employer-based health insurance rose by 9.2 percent in 2005, the fifth consecutive year of increases over 9 percent. All types of health plans—including health maintenance organizations (HMOs), preferred provider organizations (PPOs) and point-of-service plans (POS)—showed this increase. The annual premium that a health insurer charges an employer for a health plan covering a family of four averaged $10,800 in 2005. Workers contributed $2,713, or 10 percent more than they did in 2004. The annual premiums for family coverage eclipsed the gross earnings for a full-time, minimum-wage worker ($10,712).

Furthermore, increasing health care insurance premiums, health care saving accounts, and other factors are forcing employers to opt for higher deductibles and co-insurance plans. Health insurance expenses are the fastest growing cost component for employers. As a result, we have seen a dramatic decrease in the number of companies offering health care insurance plans to their employees. The resulting statistics are staggering, with nearly 46 million Americans uninsured, while, at the same time, the United States spends more on health care than other industrialized nations.

Other factors affecting the increase in health care costs are higher priced technologies, provider consolidation, increased utilization caused by increasing consumer demand, new treatments, aging population, lifestyles, popularity of cosmetic surgeries, more intensive diagnostic testing, and escalating liability and malpractice insurance premiums. With increasing utilization of health care services and increasingly complex pricing and cost structures associated with those services, health care insurers have shifted the responsibility of claim submission from the patient to the health care providers.

Given the complicated health care transaction model wherein inter-related services are provided by physicians, hospitals, clinics, imaging centers, diagnostic laboratories, therapy centers, chiropractic and ambulatory care centers, the insurance companies have developed provider contracts. These contracts set forth the terms and conditions for eligibility, such as covered services and procedures, approval, authorization processes, contractual discount terms, reimbursement rates, payment rates, carve outs, stop loss thresholds, billing and payment methodologies, rate escalators, and audit procedures.

Currently, health care providers assess and negotiate payor contracts by comparing current contract terms with other payor contracts, comparing reimbursement and payment rates provided by the government through the Medicare and Medicaid programs, conducting profit and cost analysis on prior years' performance, analyzing the volume of patients, and using contract software simulation tools. The presence of numerous processes for the evaluation of pricing, reimbursement, and discount terms makes contract analysis a very complex and time consuming process. The complexity is further increased by the way that health care providers are reimbursed. Health care providers provide services and bill insurance companies at contracted rates. Insurance companies then reimburse medical care providers a pre-determined portion of the bill based on the patient's specific insurance plan. The remaining amount (deductible, co-payment, and co-insurance) if any, is the responsibility of the patient to pay, and the responsibility of the provider to collect.

Increases in health care costs and the popularity of high deductible and co-insurance plans are transferring a bigger portion of health care costs to patients. Historically, the patient liability was a small portion of the overall reimbursement amount, and even though health care providers were only able to collect a fraction of the dollars due from the patient, the health care providers did not pay much attention to this problem. Given the recent trends, patient liability represents a tangible and increasing financial risk for health care providers.

Consumers have not only experienced a significant increase in health insurance premiums but are also bearing more of the cost of the service. Workers are now paying $1,094 more in premiums annually for family coverage than they did in 2000. The average employee contribution to company-provided health insurance has increased more than 143 percent since 2000. Average out-of-pocket costs for deductibles, co-payments for medications, and co-insurance for physician and hospital visits rose 115 percent during the same period.

The percentage of Americans under age 65 whose family-level, out-of-pocket spending for health care, including health insurance, exceeds $2,000 a year rose from 37.3 percent in 1996 to 43.1 percent in 2003—a 16 percent increase. Almost 50 percent of the American public says that they are very worried about having to pay more for their health care or health insurance, while 42 percent report they are very worried about not being able to afford health care services.

A recent study by Harvard University researchers found that the average out-of-pocket medical debt for those who filed for bankruptcy was $12,000. The study noted that 68 percent of those who filed for bankruptcy had health insurance. In addition, the study found that 50 percent of all bankruptcy filings were partly the result of medical expenses. Every 30 seconds in the United States someone files for bankruptcy in the aftermath of a serious health problem. One half of workers in the lowest-compensation jobs and one-half of workers in mid-range-compensation jobs either had problems with medical bills in a 12-month period or were paying off accrued debt. One-quarter of workers in higher-compensated positions also reported problems with medical bills or were paying off accrued debt. If one member of a family is uninsured and has an accident, a hospital stay, or a costly medical treatment, the resulting medical bills can affect the economic stability of the whole family.

As a higher portion of the health care costs are transferred to the patient, health care providers are going to experience increased bad debt and write-off associated with their inability to collect from the patients. As a result, health care providers will be paid less and less for their services, which in turn can either lead to more significant price increases or cause financial insolvencies.

To illustrate the problems facing health care providers, a hypothetical example is given in FIG. 1. As an example, let us consider two different Health Care Insurance Companies (HICs): HIC_A and HIC_B, and assume that both have negotiated pricing contracts with a specific hospital to receive a 30% discount for their policy holders for services provided by the hospital.

For the patients insured under HIC_A, as seen in FIG. 1, the hospital billed a total of $1400 for services that cost the hospital $2000 per contract terms. The net amount collected by the hospital for the services rendered was $560 or 28% of the billed charges. This is significantly lower than the negotiated 70%. Even if the hospital had provided no discount to HIC_A, the maximum amount the hospital would have received for the services it provided would have been $800 or 40% of billed charges.

For the patients insured under HIC_B, the hospital billed a total of $1400 for services that cost the hospital $2000 per contract terms. The net amount collected by the hospital for the services rendered was $1360 or 68% of the billed charges. This is slightly lower than the negotiated 70%. Even though the hospital had negotiated similar contracts with HIC_A and HIC_B, the hospital was able to receive more reimbursement from patients insured under HIC_B.

As discussed above, insurance companies have successfully been able to transfer payment risks to health care providers, and are in a proverbial sense “having their cake and eating it too.” Thus, it is imperative for health care providers to identify and evaluate the risks associated with patient payment defaults and to quantify and incorporate those risks as a part of their contracts with insurance companies. While information such as FICO scores are available, such scores do not indicate the propensity of a person or a group of people to pay medical debt, nor are such as scores generated in view of the complex contractual relationship between patients, health care providers, and health care payors.

Accordingly, there is a need in the art for systems, methods, and computer program products for predicting a person's payment of a medical debt. Similarly, there is a need in the art for systems, methods, and computer program products for predicting a propensity of a group of one or more health care participants to pay an actual or potential medical debt.

### SUMMARY OF THE INVENTION

The problems facing the health care providers as described above can be addressed by the methods, systems, and computer program products (hereinafter “method” or “methods” for convenience) of embodiments of the present invention. As used herein and as understood by one of ordinary skill in the art, “health care provider” includes any entity that directly or indirectly provides health care services, such as doctors, nurses, medical technicians, hospitals, laboratories, emergency medical services, clinics, imaging centers, therapy centers, chiropractic centers, ambulatory care centers, and the like.

Also as used herein and as understood by one of ordinary skill in the art, “health care payor” includes any entity that directly or indirectly pays for the medical debt of another entity, such as health care insurance companies, health maintenance organizations, preferred provider organizations, point-of-service plans, and the like.

For example, embodiments of the present invention allow a health care provider to negotiate more favorable terms on payor contracts. This in turn will result in better reimbursement for the services that they provide. Thus, embodiments of the present invention allow a health care provider to transfer a significant portion of the patient financial risk back to the insurance companies through the negotiations of more favorable terms. Embodiments of the present invention also enable health care providers to reduce costs associated with increasing the resources within their collection departments, and allow them to redeploy valuable resources (both human and capital) into providing better medical services for their patients.

Doctors and Physician groups have seen their cost of conducting business escalate primarily due to higher liability and malpractice insurance claims. By using embodiments of the present invention to negotiate more favorable terms, some of the increased costs can be offset by higher reimbursements from insurance companies.

Similarly, embodiments of the present invention enable health care providers to conclusively demonstrate to insurance companies that the cause for lower collections on patient liability is independent of their collection practices and is purely a function of the patient payment behavior characteristics of the population insured by the insurance company. When health care providers are evaluating a new contract, where they have had no prior history with the companies insured population, embodiments of the present invention allow health care providers to efficiently assess and incorporate patient financial risk into their contract.

By predicting the payment of a medical debt by a person or group of people, embodiments of the present invention can reduce bad debt associated with non-payment, enabling hospitals to improve their financial conditions, saving potentially millions of dollars through better bond ratings. Armed with the likelihood that patients will actually pay medical debt, health care providers will finally be able to negotiate fair contracts with insurance companies, helping to mitigate further price increases for health care.

Unless otherwise expressly stated, it is in no way intended that any method or embodiment set forth herein be construed as requiring that its steps be performed in a specific order. Accordingly, where a method, system, or computer program product claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

### BRIEF DESCRIPTION OF THE DRAWINGS

The foregoing and other advantages and features of the invention will become more apparent from the detailed description of exemplary embodiments of the invention given below with reference to the accompanying drawings.

FIG. 1 is a table showing a hypothetical relationship between a hospital and two health care insurance companies.

FIG. 2 is a block diagram of a computer system useful for implementing embodiments of the present invention.

FIG. 3 illustrates how a payment model can be generated according to one embodiment of the present invention.

FIG. 4 illustrates the separation of a population into different subgroups according to one embodiment of the present invention.

FIG. 5 illustrates one embodiment of the present invention useful for predicting a person's payment of a medical debt.

FIG. 6 illustrates one embodiment of the present invention useful for predicting a propensity of a group of one or more health care participants to pay an actual or potential medical debt.

In the following detailed description, reference is made to the accompanying drawings, which form a part hereof, and in which is shown by way of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

### DETAILED DESCRIPTION OF THE INVENTION

Before the present methods, systems, and computer program products of embodiments of the present invention are disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an encoder” includes mixtures of encoders, reference to “an encoder” includes mixtures of two or more such encoders, and the like.

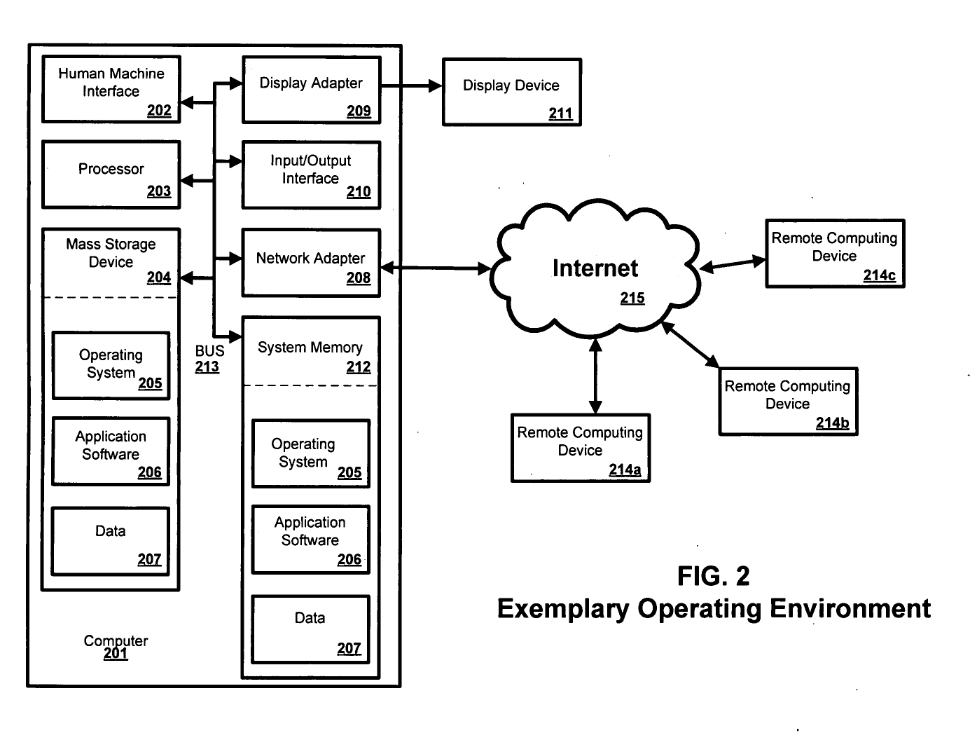

The methods of the present invention can be carried out using a processor programmed to carry out embodiments of the present invention. FIG. 2 is a block diagram illustrating an exemplary operating environment for performing the various embodiments. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Similarly, embodiments of the present invention can be carried out in whole or in part without the aid of a computing system. Examples of well known computing systems, environments, and/or configurations that may be suitable for use with the method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The method may be described in the general context of computer instructions, such as program modules, being executed by a computer. Generally, program modules include routines, programs, objects, components, data structures, etc. that perform particular tasks or implement particular abstract data types. The method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 201. The components of the computer 201 can include, but are not limited to, one or more processors or processing units 203, a system memory 212, and a system bus 213 that couples various system components including the processor 203 to the system memory 212. The processor 203 in FIG. 2 can be an x-86 compatible processor, including a PENTIUM IV, manufactured by Intel Corporation, or an ATHLON 64 processor, manufactured by Advanced Micro Devices Corporation. Processors utilizing other instruction sets may also be used, including those manufactured by Apple, IBM, or NEC.

The system bus 213 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 213, and all buses specified in this description can also be implemented over a wired or wireless network connection and each of the subsystems, including the processor 203, a mass storage device 204, an operating system 205, application software 206, data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The operating system 205 in FIG. 2 includes operating systems such as MICROSOFT WINDOWS XP, WINDOWS 2000, WINDOWS NT, or WINDOWS 98, and REDHAT LINUX, FREE BSD, or SUN MICROSYSTEMS SOLARIS. Additionally, the application software 206 may include web browsing software, such as MICROSOFT INTERNET EXPLORER or MOZILLA FIREFOX, enabling a user to view HTML, SGML, XML, or any other suitably constructed document language on the display device 211.

The computer 201 typically includes a variety of computer readable media. Such media can be any available media that is accessible by the computer 201 and includes both volatile and non-volatile media, removable and non-removable media. The system memory 212 includes computer readable media in the form of volatile memory, such as random access memory (RAM), and/or non-volatile memory, such as read only memory (ROM). The system memory 212 typically contains data such as data 207 and/or program modules such as operating system 205 and application software 206 that are immediately accessible to and/or are presently operated on by the processing unit 203.

The computer 201 may also include other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 204, including by way of example, an operating system 205 and application software 206. Each of the operating system 205 and application software 206 (or some combination thereof) may include elements of the programming and the application software 206. Data 207 can also be stored on the mass storage device 204. Data 204 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 201 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 203 via a human machine interface 202 that is coupled to the system bus 213, but may be connected by other interface and bus structures, such as a parallel port, serial port, game port, or a universal serial bus (USB).

A display device 211 can also be connected to the system bus 213 via an interface, such as a display adapter 209. For example, a display device can be a cathode ray tube (CRT) monitor or a Liquid Crystal Display (LCD). In addition to the display device 211, other output peripheral devices can include components such as speakers (not shown) and a printer (not shown) which can be connected to the computer 201 via Input/Output Interface 210.

The computer 201 can operate in a networked environment using logical connections to one or more remote computing devices 214a,b,c. By way of example, a remote computing device can be a personal computer, portable computer, a server, a router, a network computer, a peer device or other common network node, and so on. Logical connections between the computer 201 and a remote computing device 214a,b,c can be made via a local area network (LAN) and a general wide area network (WAN). Such network connections can be through a network adapter 208. A network adapter 208 can be implemented in both wired and wireless environments. Such networking environments are commonplace in offices, enterprise-wide computer networks, intranets, and the Internet 215.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of application software 206 may be stored on or transmitted across some form of computer readable media. An implementation of the disclosed method may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

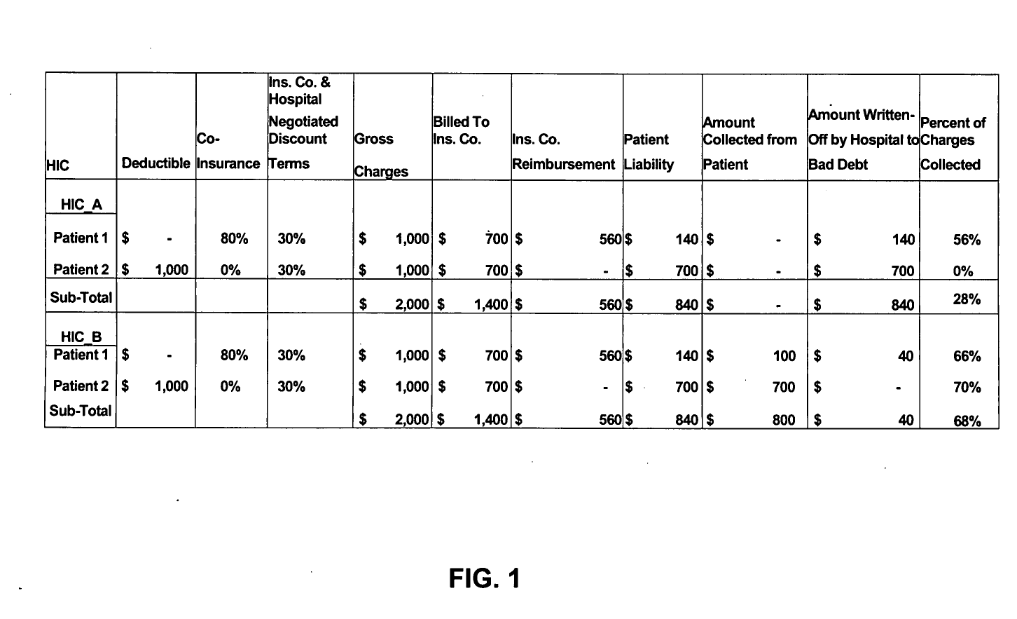

As discussed above, there is a need in the art for a method which would enable a hospital, such as the hospital of FIG. 1, to predict and then correct the poor collection rate under HIC_A, for example. As known to one of skill in the art, the first step in predicting a behavior involves uncovering the relationship between a set of potentially predictive characteristics, or independent variables, and a defined outcome, or dependent variable.

One embodiment of the present invention involves analyzing past patient behavior to develop a tool, or model, which can then be used to predict the propensity of a person or group of people to pay medical debt. First, independent variables are collected as they existed around a point of service date. In embodiments of the present invention, independent variables include health care provider internal data in whole or in part including variables such as original receivable amount, financial type or hospital service type; demographic and economic data at a regional level such as median household income or percent of the population living under the poverty level; and consumer credit file information obtained from any of the credit bureaus.

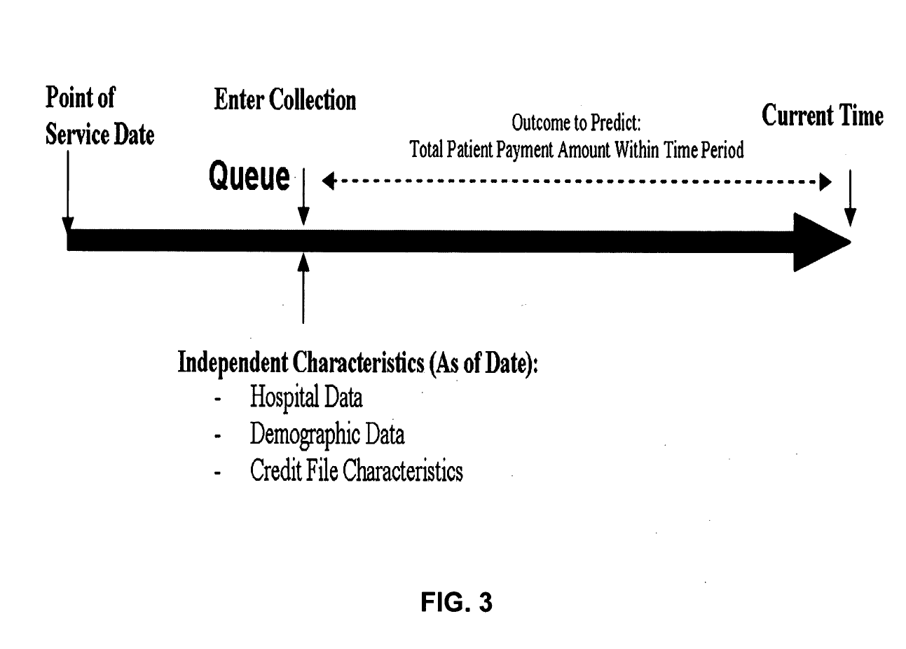

Second, a potential outcome, or dependent variable, is defined, such as a binary outcome, numerical score, continuous outcome, or a two stage outcome. A binary outcome, for example, groups patients into those that have made any payments, and those that have made no payments. A continuous outcome, for example, can be the amount collected. A two stage outcome, for example, can be the product of any payment times the amount collected. FIG. 3 illustrates how a model can be generated according to one embodiment of the present invention.

As understood by one of skill in the art, various techniques can be used to analyze and deduct the most predictive combination of variables, such as statistical regression techniques, neural networks, and the like. Depending on the type of modeling methodology used, the output results in an algorithm or model which can be used to predict payment behavior. In one embodiment of the present invention, the resulting algorithm is a computer program executable on the computer 201 of FIG. 2. In other embodiments, the algorithm is represented by a chart, table, or series of rules which can be used to predict payment behavior. The output from such an algorithm is known as a predictive indicator, code, or score.

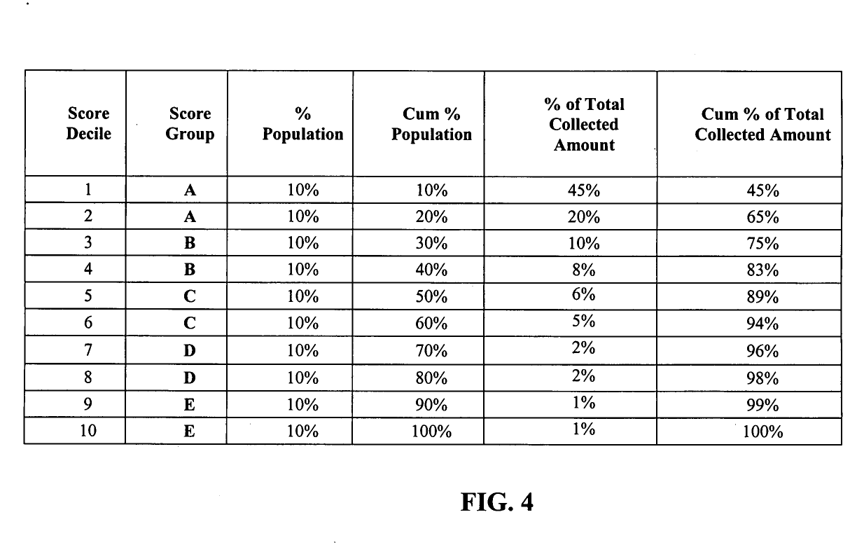

Once a model for predicting payment behavior is developed according to embodiments of the present invention, the model provides a powerful tool which enables a health care provider to distinguish between groups of patients with different outcome behaviors. Separation of a population into different subgroups via application of a model can be illustrated by a table, such as the table of FIG. 4, which is provided for illustrative purposes only. The table of FIG. 4 scores each account and then orders accounts from the highest expected outcome probability to the lowest expected outcome probability. As can be seen in FIG. 4, the population is split into ten groups, or deciles. As understood by one of skill in the art, an appropriate mathematical model or algorithm can capture a high percentage of the population's actual outcome behavior in the top scoring deciles. In FIG. 4, for instance, 75% of the total collected amount is realized in the top three deciles.

As understood by one of skill in the art, the decision to develop a health care provider specific model and the choice of different types of information considered during the development of a model depends on a variety of factors, such as the availability of different types of historical data, availability of specific outcome information, technology limitations, sample size limitations, cost associated with each solution, and whether a relationship exists between the health care provider and the specific payor.

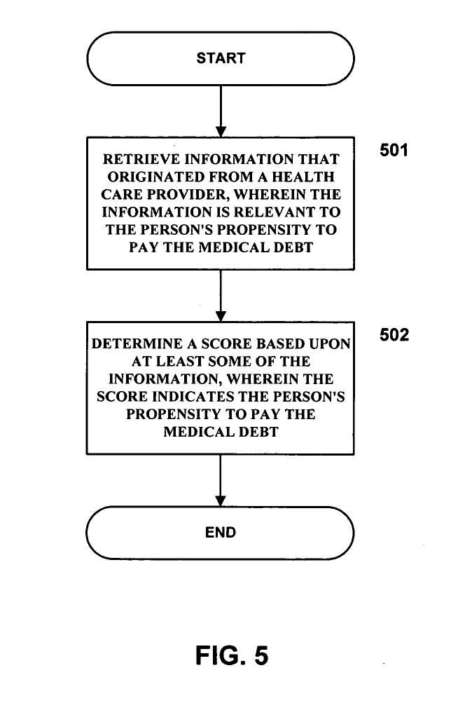

Another embodiment of the present invention provides a method for predicting a person's payment of a medical debt, and is illustrated logically in FIG. 5. One or more of the steps of FIG. 5 may be carried out on the computing device 201 of FIG. 2. First, in the embodiment of FIG. 5, information is retrieved 501 that originated from a health care provider, wherein the information is relevant to the person's propensity to pay the medical debt. Since the information originates from a health care provider, the information can include one or more of name, address, social security number, hospital identifier, gross charges, insurance adjustments, insurance liability, patient adjustments, insurance plan codes, financial class, charity adjustments, patient payments, bad debt placement amount, admit date, discharge date, and bill date. As understood by one of skill in the art, the health care provider can store and retrieve information using the computer 201 of FIG. 2.

Second in the embodiment of FIG. 5, a score is determined 502 based upon to at least some of the information, wherein the score indicates the person's propensity to pay the medical debt. A score in any embodiment of the present invention can be at least one of a binary outcome, a numerical value, a formula, or an algorithm.

In one embodiment of the present invention extending the current embodiment, the step of determining 502 a score comprises applying an algorithm to at least some of the information to determine a score, wherein the score indicates the person's propensity to pay the medical debt. The algorithm can be any of the algorithms, tools, or models discussed with respect to various embodiments of the present invention, including a neural network or a statistical model. The algorithm can then be updated based on the person's payment of the medical debt in various embodiments of the present invention.

In another embodiment of the present invention based on the embodiment of FIG. 5, information is retrieved from a health care provider and from one or more sources, wherein the information is relevant to the person's propensity to pay medical debt. A source can be at least one of an insurance provider, credit provider, consumer credit bureau, or financial institution. In alternate embodiments of FIG. 5, at least one source of information is a database external to the health care provider, where, for example, the health care provider and the database are connected over a network such as the Internet. The database can reside on a computer 201 as depicted in FIG. 2.

In a further embodiment of the present invention, the embodiment of FIG. 5 comprises the step of using the score to predict the person's payment of the medical debt or a potential medical debt. In other embodiments of FIG. 5, the score can be used for at least one of quantifying a payment risk to a health care provider, determining a health insurance premium for the person, designing a health care plan for the person, or determining the person's eligibility for a health care plan, each as understood by a person of ordinary skill in the art.

Once a score is generated according to embodiments of the present invention, the score can be used to overcome deficiencies in the art. Specifically, since the score indicates a person's propensity to pay a medical debt, the health care provider can use this information to negotiate a contract with a health care payor, with the contract taking into account the likelihood that a person will actually pay some or all of a medical debt. A health care payor can also use the score to negotiate a contract with a health care provider. In a similar fashion, the score can be used by a health care provider to negotiate a contract with a collections company, and vice versa.

In a further embodiment of the present invention based on the embodiment of FIG. 5, the steps of retrieving 501 information that originated from a health care provider and determining 502 a score based upon at least some of the information retrieved are repeated for a group of persons, and then a group score is determined for the group based on the score of each person in the group, wherein the group score indicates a propensity of the group to pay a medical debt of one or more persons in the group. Each person in the group may be participating in the same health care plan.

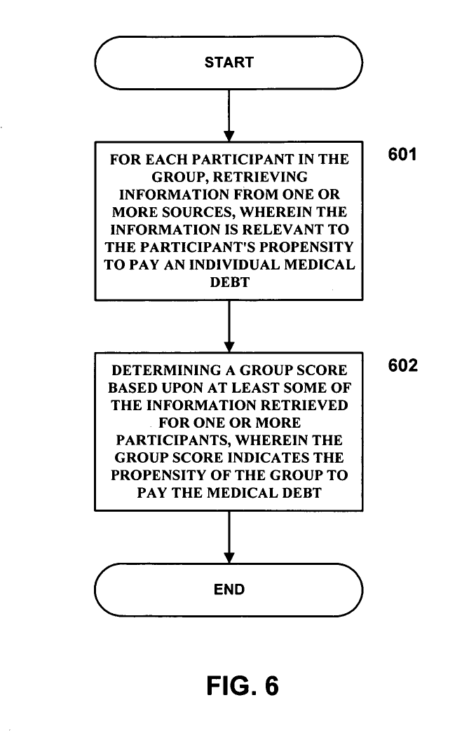

Another embodiment of the present invention is shown in FIG. 6, which illustrates a method for predicting a propensity of a group of one or more health care participants to pay an actual or potential medical debt. One or more of the steps of FIG. 6 may be carried out on the computing device 201. First in the embodiment of FIG. 6, for each participant in the group, information is retrieved 601 from one or more sources, wherein the information is relevant to a participant's propensity to pay an individual medical debt. Second, a group score is determined 602 based upon at least some of the information retrieved for one or more participants, wherein the group score indicates the propensity of the group to pay the medical debt.

In one embodiment extending the embodiment of FIG. 6, a source is at least one of a health care provider, insurance provider, credit provider, consumer credit bureau, or financial institution. The information in various embodiments can be at least one of demographic information, credit information, financial information, or a credit score, each as known to one of skill in the art. The medical debt can be a medical debt of one or more participants in the group. Further, a source can be a database residing on a computing device 201, and can be external to the health care provider.

In another embodiment extending the embodiment of FIG. 6, the determining step comprises inputting at least some of the information retrieved for one or more participants into an algorithm to determine a group score, wherein the group score indicates the propensity of the group to pay the medical debt. The algorithm in various embodiments can be at least one of a neural network or a statistical model as known to one of skill in the art.

The group score generated by embodiments of the present invention can be used to overcome deficiencies in the art. For example, in one embodiment, the group score is used to quantify a payment risk to a health care provider. In other embodiments, the group score is used by a health care provider to negotiate a contract with a health care payor, or the group score is used by a health care payor to negotiate a contract with a health care provider. In further embodiments, the group score is used by a health care provider to negotiate a contract with a collections company, or the group score is used by the collections company to negotiate a contract with a health care provider.

In a further embodiment extending the embodiment of FIG. 6, the group score is used to predict payment of at least one participant's medical debt. The group score can also be used to predict the payment of another actual or potential medical debt. The group score can be used to determine a health insurance premium for one or more participants in the group, and to design a health care plan for one or more participants in the group. Further, in some embodiments, each participant in the group can be participating in the same collections portfolio.

In another embodiment extending the embodiment of FIG. 6, the retrieved information is used for each participant in the group to determine an individual score for the participant, wherein the individual score indicates the participant's propensity to pay an actual or potential medical debt. Then, the group score is adjusted based on the individual score of one or more of the participants.

We claim:

1. A method for predicting a person's payment of a medical debt, the method comprising the steps of:
a. retrieving information that originated from a health care provider, wherein the information is relevant to the person's propensity to pay the medical debt; and
b. determining a score based upon at least some of the information, wherein the score indicates the person's propensity to pay the medical debt.

2. The method of claim 1, wherein the retrieving step comprises the step of retrieving information that originated from a health care provider and retrieving information from one or more sources, wherein the information is relevant to the person's propensity to pay the medical debt.

3. The method of claim 2, wherein a source is at least one of an insurance provider, credit provider, consumer credit bureau, or financial institution.

4. The method of claim 1, wherein the information is at least one of demographic information, credit information, financial information, or a credit score.

5. The method of claim 2, wherein the information is at least one of demographic information, credit information, financial information, or a credit score.

6. The method of claim 2, wherein at least one source is a database external to the health care provider.

7. The method of claim 1, further comprising the step of using the score to predict the person's payment of the medical debt.

8. The method of claim 1, further comprising the step of using the score to predict the person's payment of a potential medical debt.

9. The method of claim 1, further comprising the step of using the score to quantify a payment risk to a health care provider.

10. The method of claim 1, further comprising the step of using the score to determine a health insurance premium for the person.

11. The method of claim 1, further comprising the step of using the score to design a health care plan for the person.

12. The method of claim 1, wherein the determining step comprises applying an algorithm to at least some of the information to determine a score, wherein the score indicates the person's propensity to pay the medical debt.

13. The method of claim 12, further comprising the step of updating the algorithm based on the person's payment of the medical debt.

14. The method of claim 12, wherein the algorithm is at least one of a neural network or a statistical model.

15. The method of claim 1, further comprising the step of determining the person's eligibility for a health care plan based on the score.

16. The method of claim 1, further comprising repeating steps (a) through (b) for a group of persons; and then determining a group score for the group of persons based on the score of each person in the group, wherein the group score indicates a propensity of the group of persons to pay a medical debt of one or more persons in the group.

17. The method of claim 16, wherein each person in the group of persons is participating in the same health care plan.

18. The method of claim 16, further comprising the step of using the group score to predict payment of the medical debt of one or more persons in the group.

19. The method of claim 1, further comprising the step of using the score by a health care provider to negotiate a contract with a health care payor.

20. The method of claim 1, further comprising the step of using the score by a health care payor to negotiate a contract with a health care provider.

21. The method of claim 1, further comprising the step of using the score by a health care provider to negotiate a contract with a collections company.

22. The method of claim 1, further comprising the step of using the score by a collections company to negotiate a contract with a health care provider.

23. A method for predicting a propensity of a group of one or more health care participants to pay an actual or potential medical debt, the method comprising the steps of:
a. for each participant in the group, retrieving information from one or more sources, wherein the information is relevant to the participant's propensity to pay an individual medical debt; and
b. determining a group score based upon at least some of the information retrieved for one or more participants, wherein the group score indicates the propensity of the group to pay the medical debt.

24. The method of claim 23, wherein a source is at least one of a health care provider, insurance provider, credit provider, consumer credit bureau, or financial institution.

25. The method of claim 23, wherein the information is at least one of demographic information, credit information, financial information, or a credit score.

26. The method of claim 23, wherein the medical debt is a medical debt of one or more participants in the group.

27. The method of claim 23, further comprising the step of using the group score to quantify a payment risk to a health care provider.

28. The method of claim 23, further comprising the step of using the group score by a health care provider to negotiate a contract with a health care payor.

29. The method of claim 23, further comprising the step of using the group score by a health care payor to negotiate a contract with a health care provider.

30. The method of claim 23, further comprising the step of using the group score by a health care provider to negotiate a contract with a collections company.

31. The method of claim 23, further comprising the step of using the group score by a collections company to negotiate a contract with a health care provider.

32. The method of claim 23, further comprising the step of using the group score to predict payment of at least one participant's medical debt.

33. The method of claim 23, further comprising the step of using the group score to predict the payment of another actual or potential medical debt.

34. The method of claim 23, further comprising the step of using the group score to determine a health insurance premium for one or more participants in the group.

35. The method of claim 23, further comprising the step of using the group score to design a health care plan for one or more participants in the group.

36. The method of claim 23, wherein the determining step comprises inputting at least some of the information retrieved for one or more participants into an algorithm to determine a group score, wherein the group score indicates the propensity of the group to pay the medical debt.

37. The method of claim 36, wherein the algorithm is at least one of a neural network or a statistical model.

38. The method of claim 23, wherein at least one source is a database external to a health care provider.

39. The method of claim 23, wherein each participant in the group is participating in the same collection portfolio.

40. The method of claim 23, further comprising the step of using the group score to quantify a payment risk to a health care provider.

41. The method of claim 23, further comprising the steps of:
a. for each participant in the group, using at least some of the retrieved information to determine an individual score for the participant, wherein the individual score indicates the participant's propensity to pay an actual or potential individual medical debt; and
b. adjusting the group score based on the individual score of one of more of the participants.

42. A computer program product encoded in a computer readable medium, the program product for predicting a propensity of a group of one or more health care participants to pay an actual or potential medical debt, the program product encoded to perform the steps of:
a. for each participant in the group, retrieving information that originated from a health care provider and retrieving information from one or more sources, wherein a source is at least one of an insurance provider, credit provider, consumer credit bureau, or financial institution, and wherein the information is relevant to the participant's propensity to pay an individual medical debt; and
b. determining a group score based upon at least some of the information retrieved for one or more participants, wherein the group score indicates the propensity of the group to pay the medical debt.
